(19) United States
(12) Patent Application Publication
(10) Pub. No.: US 2006/0172881 A1
(43) Pub. Date: Aug. 3, 2006

(54) Method of spatially controlling catalysis of a chemical reaction

(76) Inventors: Neal K. Devaraj, Palo Alto, CA (US); James P. Collman, Stanford, CA (US); Christopher E.D. Chidsey, San Francisco, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 11/318,273

(22) Filed: Dec. 22, 2005

Related U.S. Application Data
(60) Provisional application No. 60/639,147, filed on Dec. 22, 2004.

(51) Int. Cl. B01J 37/34

(52) U.S. Cl. 502/5

(57) ABSTRACT

The present invention provides a method of spatially controlling catalysis of a chemical reaction at a surface of a substrate. With this method, a substrate is provided with two or more independently addressable electrodes at or near the surface of the substrate. Next, a first potential is applied to one or more of the electrodes. This first potential is sufficient to electrochemically generate an active catalyst from an inactive catalyst proximal to any electrode(s) that are at this first potential. Simultaneously, a second potential is applied to all other electrodes. This second potential serves to deactivate any active catalyst that may diffuse from the proximity of the electrode(s) that are at the first potential. This method results in spatially selective activation of catalyst at the electrode(s) that are at the first potential, and hence spatial localization of a chemical reaction catalyzed by the active catalyst.

### STATEMENT REGARDING FEDERALLY SPONSORED RESEARCH OR DEVELOPMENT

This invention was made in part with government support under grant no. CHE0131206 awarded by the National Science Foundation. The government has certain rights in this invention.

### FIELD OF THE INVENTION

The present invention relates generally to the control of chemical reactions. More particularly, the present invention relates to spatial control of chemical reactions through spatially selective activation of a catalyst.

### BACKGROUND

Spatial control of chemical reactions is an important goal for many applications, including polymer synthesis, oligomer syntheses, such as nucleic acid and peptide synthesis, materials science, etc. One strategy that has been used for accomplishing this goal is to use independently addressable electrodes to regulate a chemical reaction. This regulation can occur on several different levels. In one set of methods, a species is selectively adsorbed or attached to a substrate based on direct electrical stimulation of the species. Examples include electroplating and oxidative adsorption of thiols to gold surfaces. These methods have the disadvantage that the species to be immobilized must be electronically responsive, which limits the range of species that can be used. Other methods use independently addressable electrodes to selectively modify an immobilized reactant in proximity to the electrode, to make it reactive to a soluble reactant. These methods allow spatially selective coupling of a soluble reactant to an immobilized reactant. However, these methods have the disadvantage that they are limited to immobilized reactants that can be modified conveniently by electricity.

More recently, methods have been developed that allow spatially selective generation of an active catalyst. The catalyst can then be used, e.g., to selectively catalyze a chemical reaction. However, these methods are often not well suited to biological reagents and require the use of chemical scavengers to spatially localize the catalyst. The use of scavengers is not ideal since they can have deleterious effects on either the substrate or the species to be immobilized. Accordingly, there is a need in the art to develop new methods of spatially controlling chemical reactions using independently addressable electrodes.

### SUMMARY OF THE INVENTION

The present invention provides a method of spatially controlling catalysis of a chemical reaction at a surface of a substrate. With this method, a substrate is provided with two or more independently addressable electrodes at or near the surface of the substrate. Next, a first potential is applied to one or more of the electrodes. This first potential is sufficient to electrochemically generate an active catalyst from an inactive catalyst proximal to any electrode(s) that are at this first potential. Simultaneously, a second potential is applied to all other electrodes. This second potential serves to deactivate any active catalyst that may diffuse from the proximity of the electrode(s) that are at the first potential. This method results in spatially selective activation of catalyst at the electrode(s) that are at the first potential. Thus, a chemical reaction that only takes place in the presence of active catalyst can be spatially limited to the proximity of these electrode(s).

In a preferred embodiment, the chemical reaction is a covalent coupling of a reactant in solution to a reactant that is immobilized in proximity to the electrodes. In this case, selective activation of the catalyst at an electrode leads to selective coupling of the soluble reactant to the immobilized reactant in proximity to this electrode. Examples of reactions that are well suited to this method include, but are not limited to, azide-alkyne cycloaddition to form a 1,2,3-triazole. In this case, a preferred inactive catalyst is a Cu(II) coordination complex, which is reduced to a Cu(I) coordination complex by application of a reducing potential to an electrode. Once activated, the Cu(I) species catalyzes the reaction of terminal alkynes with azides to produce a 1,4-disubstituted 1,2,3-triazole linkage, an example of a Sharpless “click” reaction. Examples of other reactions that may be used according to the present invention include palladium-catalyzed coupling of aryl halides and vinyl groups, ruthenium-catalyzed olefin metathesis and ruthenium-catalyzed azide-alkyne cycloaddition forming a 1,5 disubstituted 1,2,3-triazole.

### BRIEF DESCRIPTION OF THE FIGURES

The present invention together with its objectives and advantages will be understood by reading the following description in conjunction with the drawings, in which:

FIG. 1 shows a method of spatially activating a catalyst according to the present invention.

FIG. 2 shows a method of spatially controlling catalysis of a chemical reaction according to the present invention.

FIG. 3 shows real-time monitoring by cyclic voltammetry (CV) of a reaction catalyzed according to the present invention.

FIG. 4 shows real-time monitoring by cyclic voltammetry (CV) of spatially selective catalysis of a reaction according to the present invention.

FIG. 5 shows a schematic of the reaction of FIG. 4.

FIG. 6 shows real-time monitoring by cyclic voltammetry (CV) of selectively activating catalyst at a first and then a second electrode according to the present invention.

### DETAILED DESCRIPTION OF THE INVENTION

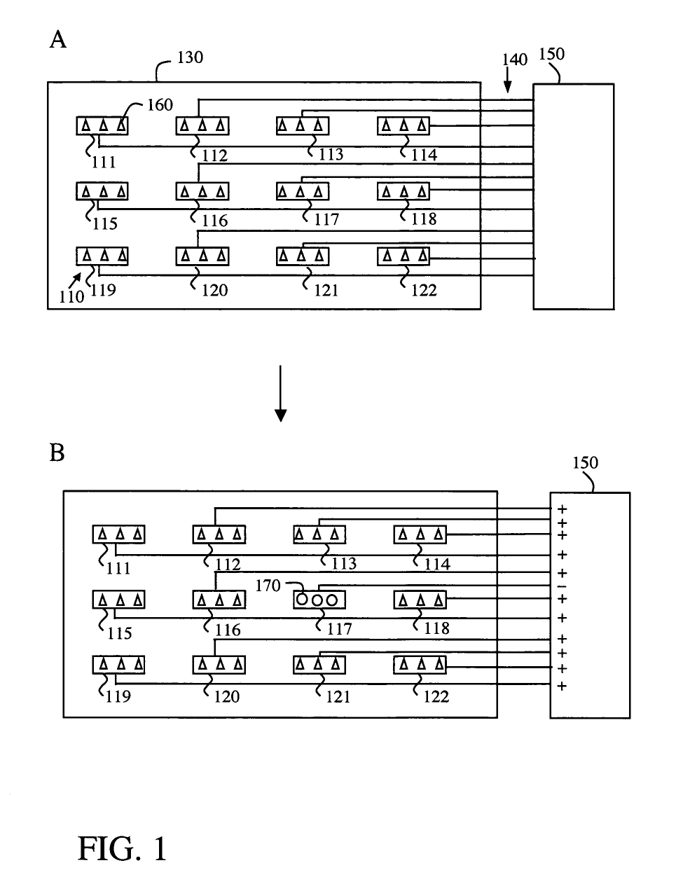

The present invention provides a method of spatially controlling catalysis of a chemical reaction at a surface of a substrate. FIG. 1 shows a top view of an embodiment of this invention. In this example, an array 110 of independently addressable electrodes 111-122 is positioned on the surface of a substrate 130. The electrodes 111-122 are individually connected, for example through wires 140, to a power source 150. The power source may be any power source, including but not limited to a bipotentiostat. Initially, inactive catalyst, indicated by triangles 160, is present in proximity to all of electrodes 111-122 (FIG. 1A). In FIG. 1B, a first potential, indicated by “−”, is applied to electrode 117 by power source 150. This potential is sufficient to activate catalyst 160 in the vicinity of electrode 117. (Active catalyst is indicated by circles 170). Simultaneously, a second potential, indicated by “+”, is applied by power source 150 to all of the other electrodes 111-116 and 118-122. This second potential is sufficient to deactivate any active catalyst 170 that diffuses away from electrode 117. Thus, active catalyst 170 is only present in the vicinity of electrode 117.

While the potentials in this example are indicated by “+” and “−”, any potentials can be used such that the first potential activates the catalyst, and the second potential deactivates the catalyst. Similarly, while the connections shown in this figure are direct wire connections, any type of connection may be used to connect the electrodes to the power source, such as CMOS switching circuitry, radio and microwave addressable switches, and light-addressable switches.

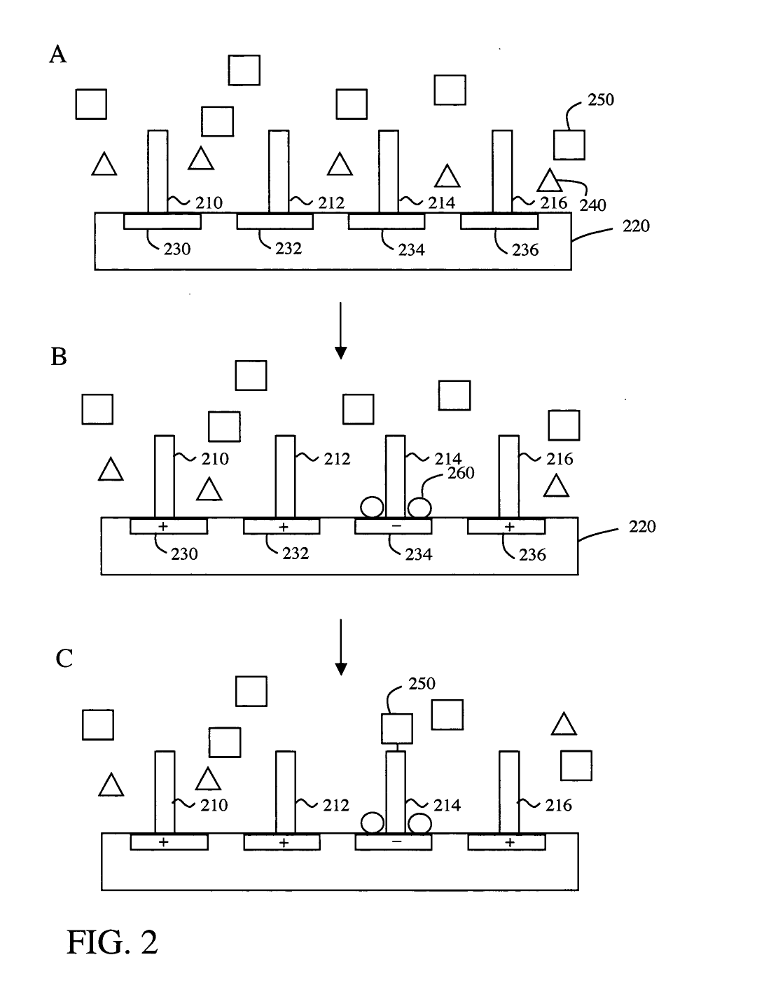

FIG. 2 illustrates a cross-sectional view of how the method of FIG. 1 may be used to spatially control catalysis of a chemical reaction at a surface of a substrate. In this example, reactants 210, 212, 214, and 216 are immobilized onto substrate 220 in proximity to electrodes 230, 232, 234, and 236, respectively. In FIG. 2A, inactive catalyst, indicated by triangles 240, as well as a second reactant, indicated by squares 250, are in solution, and are not immobilized to the surface of substrate 220. The solution may be any electrically conductive solution. Any inert electrolyte may be used to create the electrically conductive solution, including non-interfering inorganic or organic salts, acids or bases, and polymer electrolytes with only one mobile ionic species. The concentration of electrolyte may be exceedingly low, and is only limited by the rate at which it is desired to activate the catalyst and the proximity of a counter or control electrode against which a potential is applied. The electrolyte may be dissolved in any solvent, including but not limited to water, dimethylsulfoxide, butanol or any other polar organic solvent or a mixture of water and dimethylsulfoxide, butanol or a polar organic solvent.

In FIG. 2B, a first potential, indicated by “−” is applied to electrode 234, and a second potential, indicated by “+” is simultaneously applied to electrodes 230, 232, and 236. The first potential is sufficient to transform inactive catalyst 240 into active catalyst (indicated by circles 260). Preferably, the active catalyst 260 is localized at the surface of substrate 220 by a process specific to the active form of the catalyst. Examples include adsorption or precipitation of active catalyst 260. The second potential is sufficient to deactivate any active catalyst 260 that may diffuse away from electrode 234. Simultaneous application of these two potentials thus serves to localize active catalyst 260 to a region proximal to electrode 234 and reactant 214. This in turn catalyzes the reaction of second reactant 250 exclusively with reactant 214 (FIG. 2C).

While the electrodes in FIG. 2 are pictured as embedded in the substrate, they need only be in close proximity to the surface of the substrate. Thus, the electrodes could be located at, next to, below or above the substrate. The electrodes need be in sufficiently close proximity to the immobilized reactants to ensure that a chemical reaction is only catalyzed for the selected immobilized reactant. Arrays of electrodes of any dimension may be used, with the number of electrodes preferably in the range of 2 to 1000. The electrodes may be made of gold, palladium, platinum, silver, doped semiconductors, or any other conductive or semiconductive inorganic or organic material.

Any substrate may be used according to the present invention. Examples of substrates include, but are not limited to, gold, silicon, glass, indium-tin oxide, carbon, titanium, silver, platinum, palladium, or plastic.

Catalysts that can be activated electrochemically at the electrodes may be activated by reduction or oxidization. If the catalyst is activated by reduction, an oxidizing potential is simultaneously applied to the non-reduced electrodes. If the catalyst is activated by oxidation, a reducing potential is simultaneously applied to the non-oxidized electrodes. A preferred range of reduction potentials is between about −0.3V and +0.3V vs. Ag/AgCl/KCl. A preferred range of oxidation potentials is between about 0V and +0.6V vs. Ag/AgCl/KCl.

Preferably, the catalyst is a transition metal-containing species. More preferably, the inactive catalyst is a Cu(II) coordination complex, such as Cu(II) bis-bathophenanthrolinedisulphonic acid or Cu(II) tris-(triazolylmethyl)amine and the active catalyst is a reduced (Cu(I)) form of the coordination complex.

Preferably, the catalyst catalyzes the covalent coupling of a reactant in solution to an immobilized first reactant. More preferably, the catalyst catalyzes an azide-alkyne cycloaddition to form a 1,4-disubstituted 1,2,3-trizole, i.e. a Sharpless “click” reaction. In this case, one of the two reactants is an organic azide and the other reactant is an alkyne.

Details on the adaptation of this reaction to surfaces can be found in, e.g., ““Clicking” Functionality onto Electrode Surfaces”, Collman et al., Langmuir 2004, 20, 1051-1053; “Chemoselective Covalent Coupling of Oligonucleotide Probes to Self-Assembled Monolayers”, Devaraj et al., J. Am. Chem. Soc. 2005, 127, 8600-8601; and U.S. Provisional Patent Application No. 60/639,147, all of which are hereby incorporated by reference.

This method may also be used to accomplish repeated coupling reactions of different reactants to the proximity of different electrodes. In this case, a first solution having a first reactant would be contacted with the substrate and selectively coupled to an immobilized reactant or the substrate by activating catalyst at selected electrode(s). After this coupling has occurred, the substrate would be rinsed and contacted with a second solution having a second reactant. This second reactant could then be coupled in proximity to different electrode(s) by activating catalyst at the different electrode(s). Alternatively, the second reactant could be coupled to the first reactant by activating the same electrode(s) as activated in the first reaction. The process may be repeated any number of times with any number of reactants.

### EXAMPLES

Electrochemical Generation of Active Copper( I) Catalyst on an Electrode

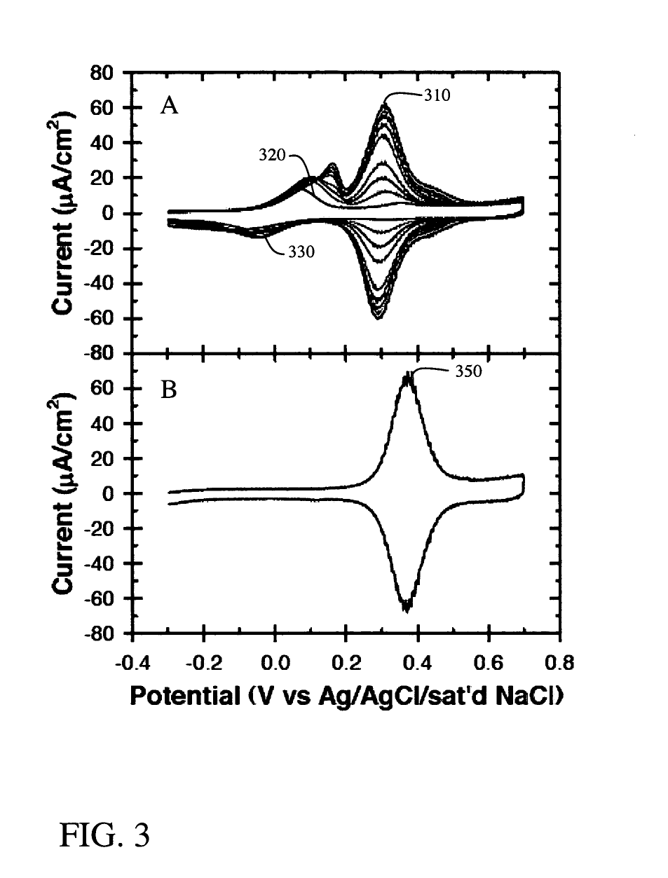

Mixed azide-terminated self-assembled monolayers (SAMs) were formed by soaking gold-coated silicon wafers in thiol solutions as previously described (see ““Clicking” Functionality onto Electrode Surfaces”, Collman et al., Langmuir 2004, 20, 1051-1053). The electrode was contacted with a solution of 0.1M KPF₆, 0.5 μM copper(II) bis-bathophenanthrolinedisulphonic acid and 0.5 μM of ethynylferrocene. These low concentrations allow detection of surface-bound redox species against the minute electrochemical signals due to solution species. The gold electrode was biased at −300 mV versus a Ag/AgCl/saturated NaCl reference electrode. This potential is roughly 300 mV negative of the Cu(II/I) standard potential of the catalyst, ensuring that Cu(I) is formed at the electrode surface. FIG. 3A shows real-time monitoring by cyclic voltammetry (CV) of the progress of the Cu(I) catalyzed coupling of ethynylferocene to the SAM monolayer. In this figure, scans were taken every 2 minutes during the 18 minute functionalization of the monolayer by ethynylferrocene. Over a period of minutes, a clear surface-immobilized ferrocene signal 310 grows in at +300 mV vs. Ag/AgCl/sat'd NaCl. The initial CV was also able to detect some ferrocene 320 that is either non-specifically bound or in solution. CVs taken with only the catalyst present (not shown) show that the kinetically slow couple 330 observed at 0 mV vs. Ag/AgCl/sat'd NaCl is due to surface-localized copper species. The surface bound nature of the copper complex was established by observing a linear relationship between the anodic peak current and scan rate.

When the ferrocene signal ceased to grow, the electrode was disconnected and cleaned with water, ethanol, chloroform, ethanol, and then water to ensure that any noncovalently bound copper and ferrocene was removed. The electrode was then contacted with 1M HClO₄. A CV (FIG. 3B) indicates that the ethynylferrocene had coupled to the surface, indicated by peak 350. Control reactions were performed in an identical manner but with the electrode left at the open-circuit potential or with a monolayer that contained no azide-terminated thiols. In either case, no ferrocene surface couple was detected (not shown). The general technique showed an excellent tolerance to reaction conditions, working well in mixed solvents (such as water and dimethysulfoxide), with mixed monolayers containing either aromatic or alkyl azides and hydrophilic or hydrophobic diluent thiols, as well as with other copper complexes such as a water-soluble Cu(II) tris-(triazolylmethyl)amine.

Selective Functionalization of Independently Addressable Microelectrodes

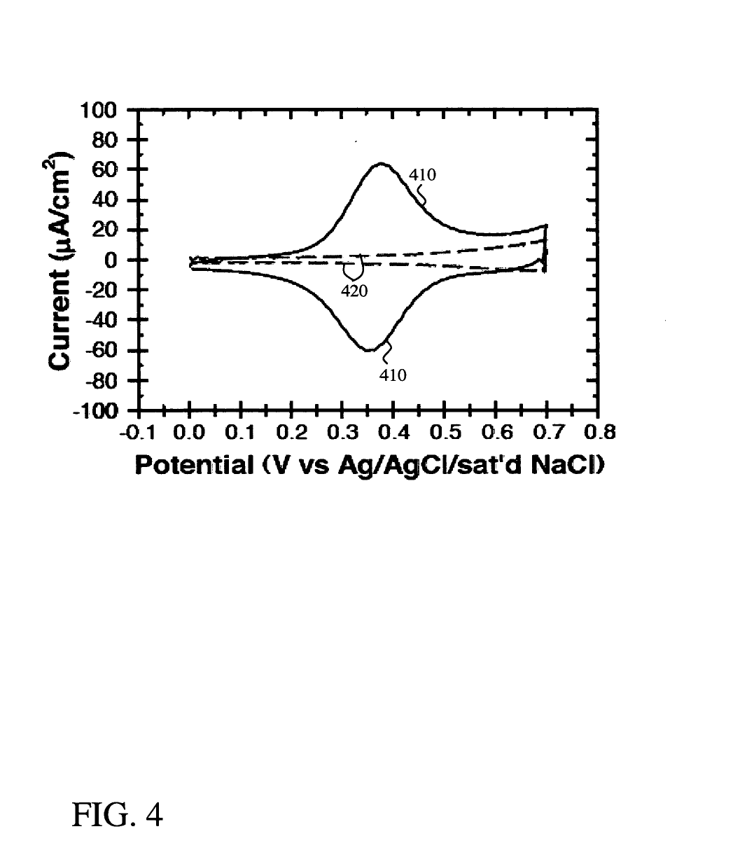

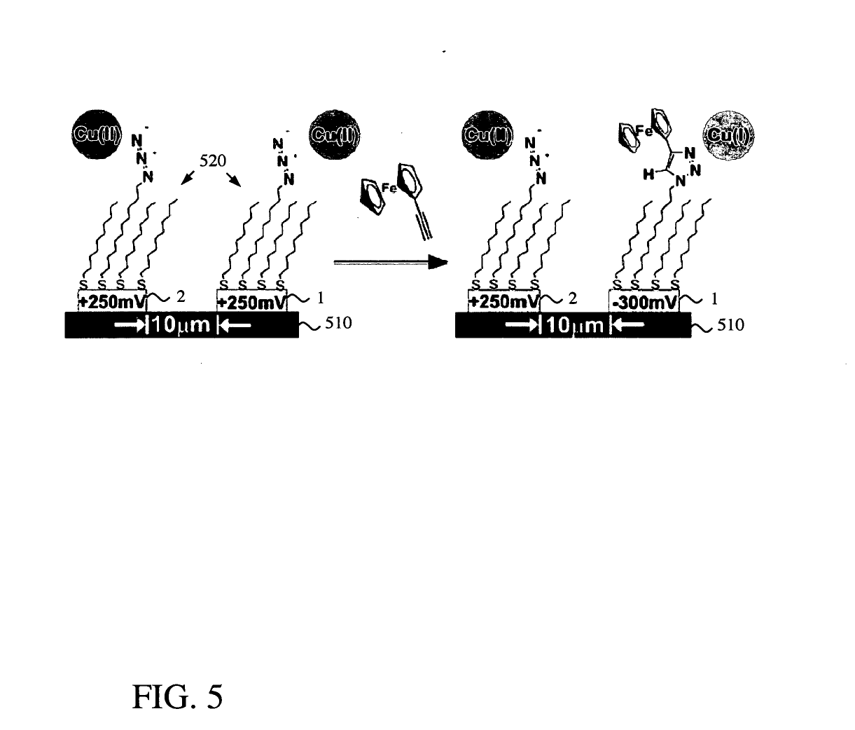

To demonstrate that this technique can be applied to the selective functionalization of independently addressable microelectrodes, the Sharpless “click” reaction was performed on a commercially available pair of gold interdigitated array (IDA) band electrodes (Abtech Scientific). The IDA was composed of two electrodes, each containing 50 Au fingers 5 mm long by 10 μm wide, with an interelectrode spacing of 10 μm. Identical mixed azide-terminated self-assembled monolayers were formed on both gold electrodes. The IDA was contacted with a solution of 0.1M KPF₆, 1 μM copper(II) bis-bathophenanthrolinedisulphonic acid and 5 μM ethynylferrocene. The electrode we wished to functionalize (Electrode 1) was held at −300 mV whereas the electrode we did not want to functionalize (Electrode 2) was held at +250 mV vs. Ag/AgCl/saturated NaCl using a bipotentiostat (Pine Instruments). After 30 minutes, both electrodes were disconnected, rinsed, and contacted with 1M HClO₄ electrolyte. As the CV in FIG. 4 shows, Electrode 1 (indicated by solid lines 410) was found to be functionalized with ferrocene whereas Electrode 2 (indicated by dashed lines 420) was not. This experiment is shown schematically in FIG. 5, with substrate 510, Electrode 1, Electrode 2, and mixed azide-terminated self-assembled monolayers 520 indicated. FIG. 5 shows that when Electrode 1 and Electrode 2 are held at the same potential, the copper(II) complex is not reduced. In contrast, when Electrode 1 is held at −300 mV and Electrode 2 is held at +250 mV, the Cu(II) complex is reduced only in the vicinity of Electrode 1, where it catalyzes the reaction between ethynylferrocene and the mixed azide-terminated self assembled monolayer.

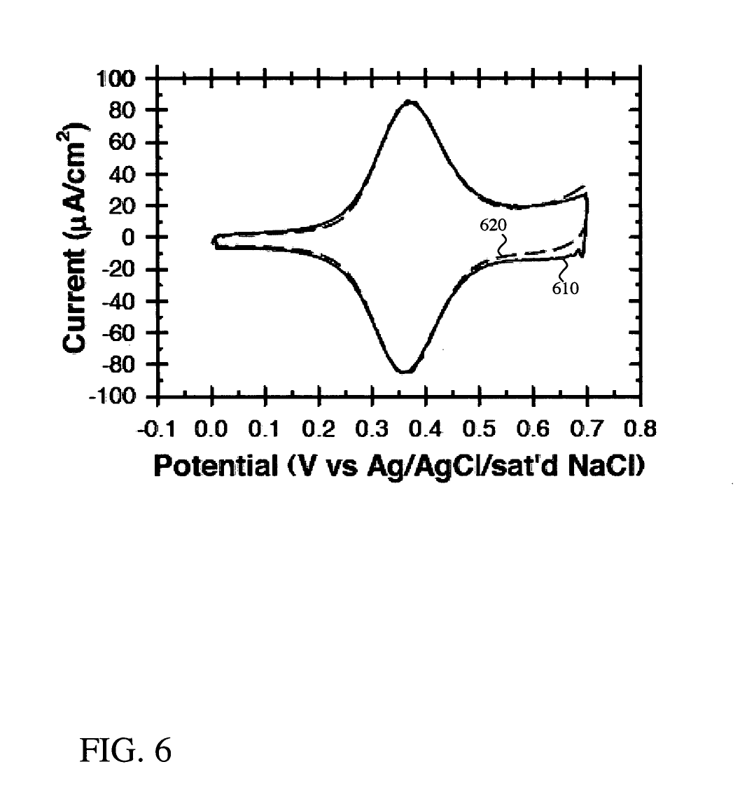

In a separate experiment the two electrodes were each functionalized in succession by first holding Electrode 1 at −300 mV and Electrode 2 at +250 mV for 30 minutes and then switching the voltages at which the electrodes were held and again holding for thirty minutes. The CVs depicted in FIG. 6 show that both electrodes are equally functionalized. (Electrode 1 is indicated by solid lines 610 and Electrode 2 is indicated by dashed lines 620).

As one of ordinary skill in the art will appreciate, various changes, substitutions, and alterations could be made or otherwise implemented without departing from the principles of the present invention. Accordingly, the scope of the invention should be determined by the following claims and their legal equivalents.

What is claimed is:

1. A method of spatially controlling catalysis of a chemical reaction at a surface of a substrate, comprising:
(a) providing a substrate having two or more independently addressable electrodes at or in close proximity to its surface;
(b) applying a first potential to one or more of said independently addressable electrodes, wherein said first potential is sufficient to electrochemically generate an active catalyst from an inactive catalyst proximal to said one or more independently addressable electrodes; and
(c) simultaneously applying a second potential to any of said independently addressable electrodes for which said first potential was not applied, wherein said second potential is sufficient to deactivate any of said active catalyst that has diffused from the proximity of said one or more independently addressable electrodes at said first potential.

2. The method as set forth in claim 1, wherein said inactive catalyst comprises a transition-metal containing species.

3. The method as set forth in claim 2, wherein said transition metal containing species comprises a copper(II) coordination complex.

4. The method as set forth in claim 3, wherein said copper(II) coordination complex comprises copper(II) bis-bathophenanthrolinedisulphonic acid or copper(II) tris-(triazolylmethyl)amine.

5. The method as set forth in claim 1, wherein said active catalyst is localized at said surface by a process specific to said active catalyst.

6. The method as set forth in claim 5, wherein said process comprises adsorption or precipitation.

7. The method as set forth in claim 1, wherein said active catalyst comprises a surface-localized copper species.

8. The method as set forth in claim 1, wherein said first potential is between −0.3V and +0.3V vs. Ag/AgCl/KCl and said second potential is between 0.0V and +0.6V vs. Ag/AgCl/KCl.

9. The method as set forth in claim 1 wherein said first potential is between 0.0V and +0.6V vs. Ag/AgCl/KCl and said second potential is between −0.3V and +0.3V vs. Ag/AgCl/KCl.

10. The method as set forth in claim 1, wherein said surface further comprises a first reactant immobilized to said surface, wherein said first reactant is proximal to one of said independently addressable electrodes.

11. The method as set forth in claim 10, wherein said chemical reaction comprises covalently coupling a second reactant to said immobilized first reactant.

12. The method as set forth in claim 9, wherein said first or second reactant comprises an organic azide or an alkyne.

13. The method as set forth in claim 9, wherein said chemical reaction comprises an azide-alkyne cycloaddition to form a 1,4-disubstituted 1,2,3-triazole.

14. The method as set forth in claim 10, wherein said second reactant is in solution.

15. The method as set forth in claim 14, wherein said solution comprises water, a polar organic solvent or a mixture of water and a polar organic solvent.

16. The method a set forth in claim 15, wherein said polar organic solvent is dimethylsulfoxide or butanol.

17. The method as set forth in claim 1, wherein said substrate has between 2 and 1000 of said independently addressable electrodes at its surface.

18. The method as set forth in claim 1, wherein said substrate comprises gold, silicon, glass, indium-tin oxide, carbon, titanium, silver, platinum, palladium, or plastic.
